(19) United States
(12) Patent Application Publication
(10) Pub. No.: US 2016/0156170 A1
(43) Pub. Date: Jun. 2, 2016

(54) SERVER WITH POWER SOURCE PROTECTION SYSTEM AND POWER SOURCE PROTECTION METHOD

(71) Applicants: Inventec (Pudong) Technology Corporation, Shanghai (CN); INVENTEC CORPORATION, Taipei City (TW)

(72) Inventor: Ying-Xian HAN, Shanghai (CN)

(21) Appl. No.: 14/596,239

(22) Filed: Jan. 14, 2015

(30) Foreign Application Priority Data
Nov. 27, 2014 (CN) 201410698217.4

(51) Int. Cl. H02H 3/08; G06F 1/32; H02H 3/06

(52) U.S. Cl. CPC H02H 3/08; H02H 3/06; G06F 1/3287

(57) ABSTRACT

A server with a power source protection system and a method thereof are provided herein, in which the server includes a power-controlling device and a hard disk drive connector. The power-controlling device includes an input unit that receives an input voltage, an output unit that outputs a load voltage, a switching unit coupled between the input unit and the output unit, and a processor coupled to the switching unit. The processor monitors a load current and controls the switching unit to turn on or off an output of the load voltage. The hard disk drive connector coupled to the output unit receives the load voltage. When the bad current exceeds a predetermined current value, the processor turns off the switching unit for a cut-off period and retries to turn on the switching unit after the cut-off period so as to output the load voltage.

### RELATED APPLICATIONS

This application claims priority to Chinese Application Serial Number 201410698217.4, filed Nov. 27, 2014, which is herein incorporated by reference.

### BACKGROUND

1. Field of Invention

The present invention relates to a power source protection technology. More particularly, the present invention relates to a server with a power source protection system and a power source protection method.

2. Description of Related Art

Storage capacity and data processing capability of a hard disk drive (HDD) play important roles in a server system. Especially, in the recent development, data transmission capability has been rapidly improved, and a huge amount of data processing more relies on the stable operation of the hard disk drive. Thus, power source protection of a hard disk drive connector becomes more important. Conventional skills mostly use thermal resistors for the power source protection of the hard disk drive connector. However, the thermal resistors merely provide passive protection, and has a limited effect of reducing the system damage once power source breakdown happens, and in a worst case, such protection may still result in an abnormal operation of the hard disk drive, thus further impacting the functions of the entire server system.

### SUMMARY

In order to protect a power source of a hard disk drive connector, an aspect of the present disclosure provides a server with a power source protection system. The server includes a power-controlling device and a hard disk drive connector, wherein the power-controlling device includes an input unit, an output unit, a switching unit, and a processor. The input unit receives an input voltage, and the output unit outputs a load voltage. The switch unit is coupled between the input unit and the output unit. The processor coupled to the switching unit monitors a load current and controls the switching unit to turn on or turn off the load voltage. The hard disk drive connector coupled to the output unit receives the load voltage, wherein when the load current exceeds a predetermined current value, the processor turns off the switching unit for a cut-off period, after the cut-off period, the processor retries to turn on the switching unit to output the load voltage.

In an embodiment of the present disclosure, the power source protection system further includes an expander that sends an enabling signal to the processor to turn on the switching unit and then to output the load voltage.

In an embodiment of the present disclosure, wherein the expander stops sending the enabling signal before detecting that the hard disk drive connector is electrically connected to the output unit.

In an embodiment of the present disclosure, the power source protection system further includes a light indicator showing a power source status of the hard disk drive connector, wherein a pre-charge stage is included in a duration when the output unit outputs the load voltage.

In an embodiment of the present disclosure, wherein when the expander detects that a power source of the hard disk drive connector fails, the expander sends the enabling signal to the processor again to turn on the switching unit and then to output the load voltage.

Another aspect of the present disclosure provides a power source protection method including the following steps. In the power source protection method, an input voltage is received. A load voltage is outputted when a switching unit is turned on, and the load voltage is received by a hard disk drive connector. A load current is monitored, and the switching unit is controlled to turn on or off an output of the load voltage. The switching unit is turned off for a cut-off period when the load current exceeds a predetermined current value, and the processes of turning on the switching unit to output the load voltage are retried after the cut-off period.

In an embodiment of the present disclosure, in the power source protection method, an enabling signal sent by an expander is received to turn on the switching unit and then to output the load voltage.

In an embodiment of the present disclosure, in the power source protection method, the processes of sending the enabling signal is stopped before the expander detects that the hard disk drive connector is electrically connected to the output unit.

In an embodiment of the present disclosure, in the power source protection method, a power source status of the hard disk drive connector is shown by a light indicator, and a pre-charge stage is included in a duration when the load voltage is outputted.

In an embodiment of the present disclosure, in the power source protection method, wherein when the expander detects that a power source of the hard disk drive connector fails, the expander sends the enabling signal to the processor again to turn on the switching unit and then to turn on the load voltage.

In sum, the present disclosure is directed to improving the hard disk drive protection against over-current by turning of a load voltage immediately when an over-current phenomenon occurs, and by retrying to turn on the output of the load voltage after the load voltage is turned off for a certain period of time and the causes of the over-current are removed.

The following is detailed description of the aforementioned contents through embodiments, and provides further explanation of the technical aspects of the present disclosure.

### BRIEF DESCRIPTION OF THE DRAWINGS

In order to make the aforementioned contents, and other purposes, features, advantages, and embodiments more clear and understandable, with description made to the accompanying drawings as follows:

FIG. 1 is a schematic diagram of a server with a power source protection system according to a first embodiment of the present disclosure;

FIG. 2 is a schematic diagram of a server with a power source protection system according to a second embodiment of the present disclosure;

FIG. 3 is a schematic diagram of a server with a power source protection system according to a third embodiment of the present disclosure; and

FIG. 4 is a flow chart of a power source protection method according to a fourth embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

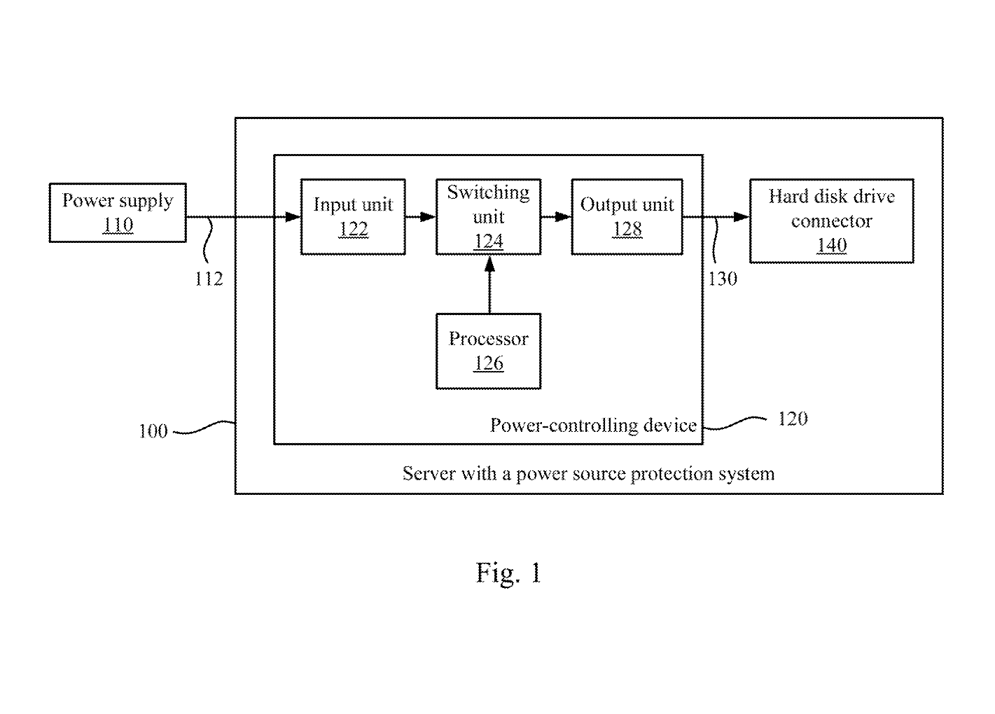

FIG. 1 is a schematic diagram showing a server 100 with a power source protection system according to a first embodiment of the present disclosure. The server 100 includes a power-controlling device 120 and a hard disk drive connector 140, wherein the power-controlling device 120 includes an input unit 122, an output unit 128, a switching unit 124 and a processor 126. In practice, the input unit may include at least one input terminal, DC-to-AC circuits, AC-to-DC circuits and circuits of transformers, and so on. The output unit 128 may include at least one output terminal, DC-to-AC circuits, AC-to-DC circuits and circuits of transformers, and so on. The switching unit 124 may be metal-oxide-semiconductor field-effect transistors (MOSFETs), bipolar junction transistors (BJTs), logic circuits, other components or circuits with switching functions, and so on. The hard disk drive connector 140 may have a serial advanced technology attachment (SATA) interface, a serial attached small computer system interface (SAS), or another interface. The processor 126 may be a central processing unit (CPU), a microprocessor or another circuit, wherein the input unit 122, the output unit 128, the switching unit 124 and the processor 126 may be integrated into one single chipset to save circuit areas.

The input unit 122 receives an input voltage 112 from a power supply 110, and is electrically connected to the output unit 128 by using the processor 126 to turn on the switching unit 124, thereby outputting a load voltage 130 to a hard disk drive connector 140. The processor 126 has the capability of monitoring a load current. When the load current of the hard disk drive connector 140 exceeds a predetermined current value, the processor 126 turns off the switching unit 124, and meanwhile the output unit 128 and the input unit 122 are electrically isolated, thereby stopping the output of the load voltage 130. After detecting that the over-current phenomenon is overcome, the processor 126 retries to turn on the switching unit 124, so as to recover the output of the load voltage 130. A period from a time point at which the switching unit 124 is turned off by the processor 126 to another time point at which the processor 126 retries to turn on the switching unit 124 is referred to as a cut-off period. In other words, the cut-off period is the time required for overcome the over-current phenomenon, so as to avoid causing damages to the hard disk drive connector again when the output is turned on again when the over-current phenomenon is not overcome yet.

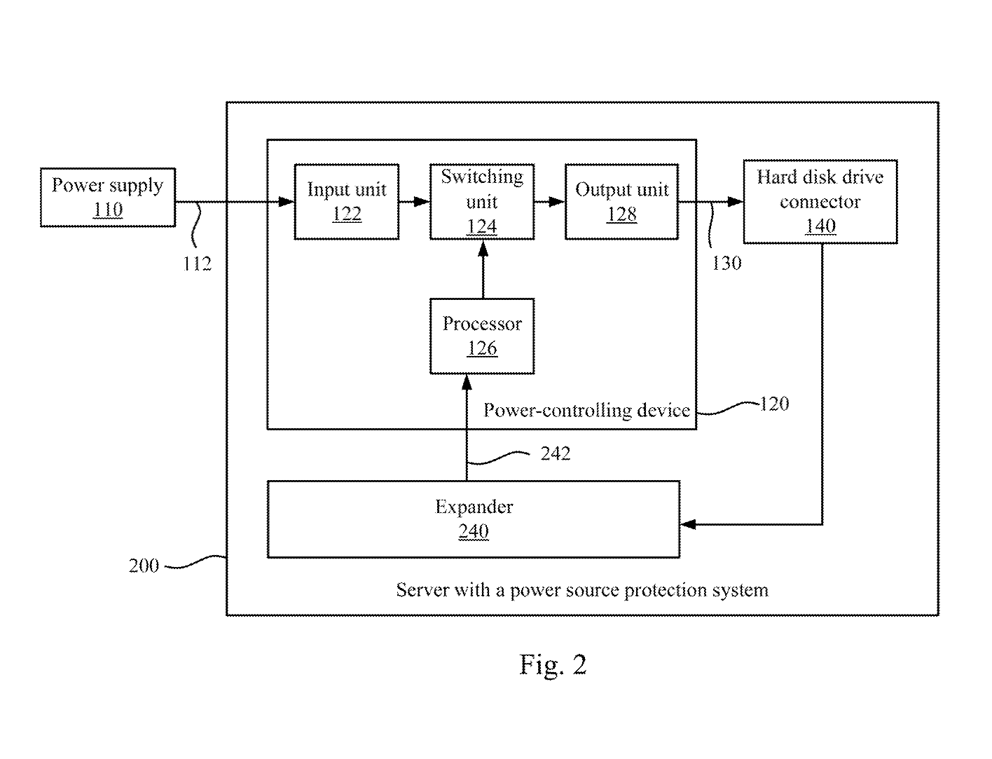

In order to control the output of the load voltage, FIG. 2 is a schematic diagram showing a server 200 with a power source protection system according to a second embodiment of the present disclosure. The server 200 has substantially the same hardware as the server 100 in FIG. 1 except an additional expander 240. In practice, the expander 240 may include multiple circuits such as logic circuits, control circuits, filter circuits, registers, at least one input terminal and at least one output terminal.

The expander 240 sends an enabling signal 242 to the processor 126 to turn on the switching unit 124, and then the load voltage 130 is outputted. In practice, the hard disk drive connector 140 requires p5v and p12v power supplies, which can be turned on by two power-controlling units 120 using the same enabling signal 242. The expander 240 can independently send twenty-four enabling signals 242, i.e. the expander 240 can control twenty-four sets of load voltage output of p5v and p12v. The expander 240 can be flexibly adjusted by using firmware to control the manner of sending the enabling signal according to user requirements, thereby stabilizing the operation of the server system.

In one embodiment, the expander 240 can detect whether the hard disk drive connector 140 is electrically connected to the output unit 128. If the hard disk drive connector 140 is electrically connected to the output unit 128, the expander 240 can send the enabling signal 242 to the processor 126 according to the settings of firmware, so as to control the stable operation of the load voltage 130. If the hard disk drive connector 140 is not electrically connected to the output unit 128, the expander 240 stops sending the enabling signal 242 to the processor 126, and there is no output of the load voltage 130 at this moment.

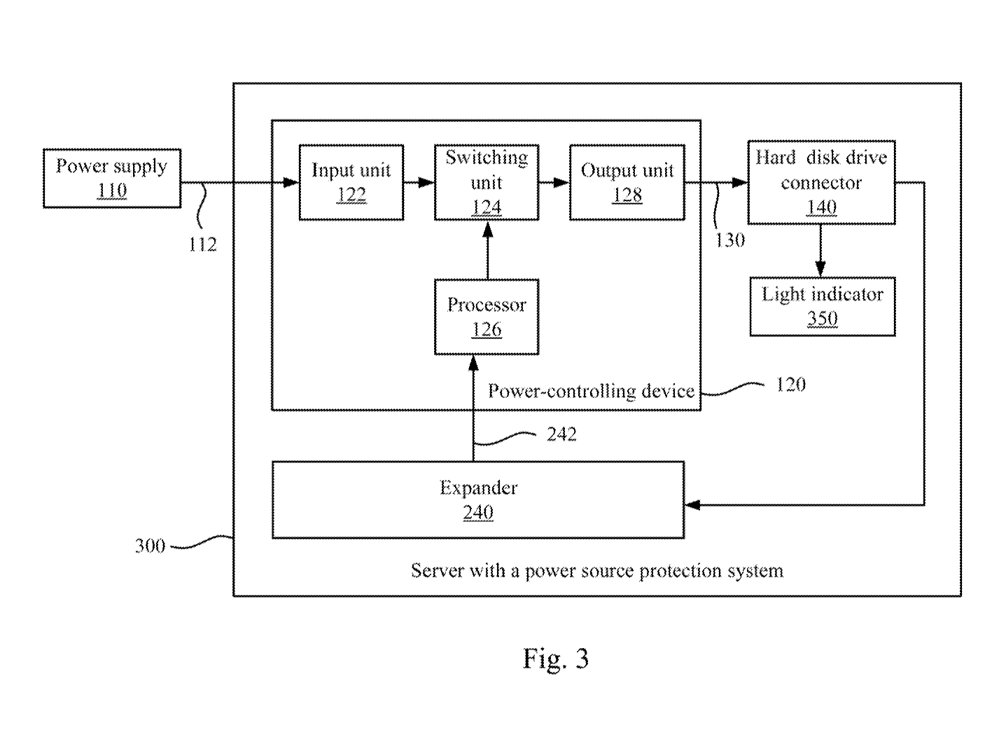

In order to monitor a power source status of the hard disk drive connector, FIG. 3 is a schematic diagram showing a server 300 with a power source protection system according to a third embodiment of the present disclosure. The server 300 has substantially the same hardware as the server 200 in FIG. 2 except an additional light indicator 350. The light indicator 350 can show the normality or abnormality (the power source status) of the power source of the hard disk drive connector 140. In practice, the light indicator 350 may be a light-emitting diode device or another display component or device that can be used to identify different statuses.

In an embodiment, a pre-charge stage is included in a duration when the output unit 128 outputs the load voltage 130, in which the value of output current is limited to avoid an inrush current causing damages to the hard disk drive connector 140 during the initial output stage of the load voltage 130. Therefore, resistor-capacitor (RC) circuits used for pre-charging can be omitted, thereby achieving the effect of saving circuit areas. In general, the inrush current is limited to be lower than the aforementioned predetermined current value, thereby preventing the processor 126 from immediately turning off the switching unit 124 resulting in an output failure when the load voltage 130 is outputted.

In an alternative embodiment, the expander 240 detects a feedback signal from the hard disk drive connector 140 to monitor the hard disk drive connector. If the power source of the hard disk drive connector 140 is doubted to be damaged, the expander 240 will send the enabling signal 242 to the processor 126 again at this moment to output the load voltage 130 to the hard disk drive connector 140 again, thereby confirming whether the power source is damaged. As described above, the expander can independently send twenty-four enabling signals and detect voltage level changes of the twenty-four enabling signals. In practice, the function of detecting the voltage level changes can be implemented by disposing logic circuits and filter circuits in the expander 240.

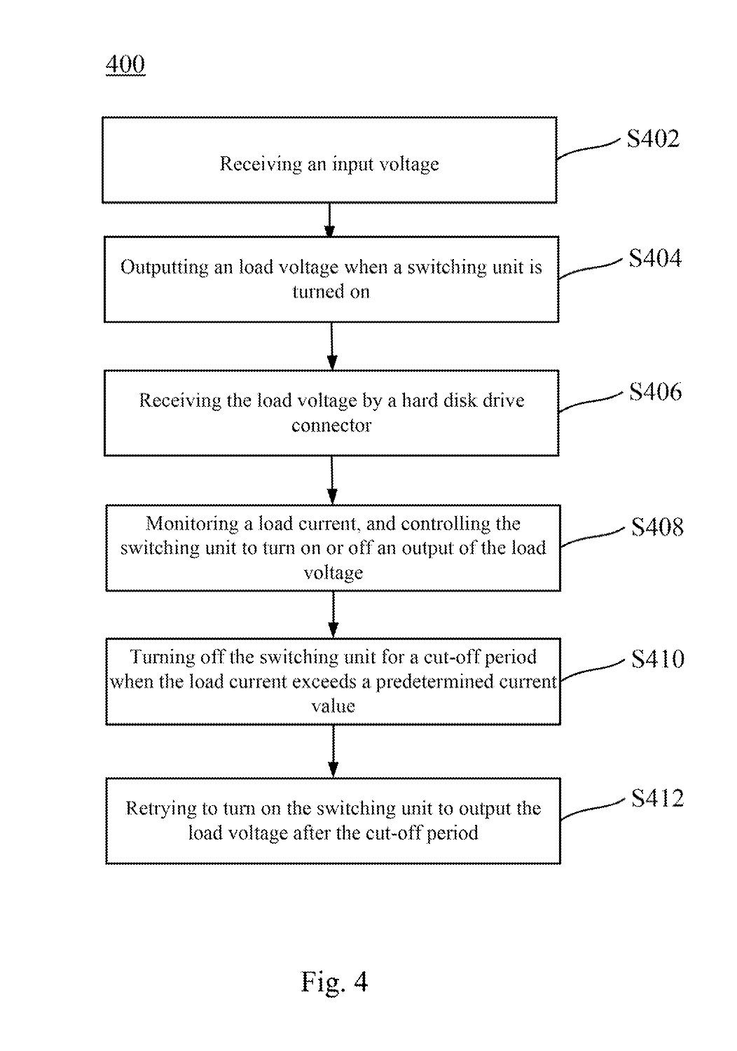

FIG. 4 shows a flow chart of a power source protection method 400 according to a fourth embodiment of the present disclosure. The power source protection method 400 can be implemented by a circuit system, for example, the aforementioned mentioned server 100, 200 or 300 with the power source protection system, and some of the aforementioned functions also can be implemented as at least one chipset to save circuit areas.

As shown in FIG. 4, the power source protection method 400 includes a plurality of steps S402-S412. However, those skilled in the art should understand that the sequence of the steps in the present embodiment can be adjusted according to actual needs unless is specified. All or parts of the steps can even be executed simultaneously. Because the hardware used to implement the steps are specifically disclosed in the above embodiments, the description will not be repeated hereinafter.

First, in step S402, an input voltage is received. Then, in step S404, the input voltage is outputted to a load when a switching unit is turned on, wherein a load voltage can be designed as the same voltage as the input voltage or another voltage that is transformed by the circuits of transformers. In step S406, the hard disk drive connector receives the load voltage as an operating voltage. In step S408, a load current during the operation of the hard disk drive connector is continuously monitored to check whether an over-current phenomenon occurs, and the switching unit is controlled to turn on or off the output of the load voltage. When the load current exceeds a predetermined current value, the switching unit is turned off for a cut-off period (Step S410). On the contrary, if the load current is lower than the predetermined current value, the load voltage keeps being outputted. In step S412, the processes of turning on the switching unit and then outputting the load voltage are retried after the cut-off period. If the load current still exceeds the predetermined current value, then the switching unit waits to be turned on until it is detected that the load current is lower than the predetermined current value. Consequently, it can be assured that the load current is within the range of the predetermined current, thus avoiding causing damages to the hard disk drive connector again.

In order to control the output of the load voltage, an enabling signal is sent to the processor by the expander, so as to turn on the switching unit, and then the load voltage is outputted. In practice, the hard disk drive connector 140 requires p5v and p12v power supplies, which can be turned on by two power-controlling units using the same enabling signal. The expander can independently send twenty-four enabling signals, i.e. the expander can control twenty-four output sets of p5v and p12v power supplies. The expander can be flexibly adjusted by using firmware to control the manner of sending the enabling signal according to user requirements, thereby stabilizing the operation of the server system.

In an embodiment, the expander can detect whether the hard disk drive connector is electrically connected. If the hard disk drive connector 140 is electrically connected, then the expander can send the enabling signal to control the stable operation of the load voltage. If the hard disk drive connector is not electrically connected, then the expander stops sending the enabling signal, and there is no output of the load voltage at this moment.

In order to monitor the power source status of the hard disk drive connector, the normality or abnormality of the power source of the hard disk drive connector can be shown by a light indicator. In practice, the light device can be a light-emitting diode device or another displaying component or device that can identify different statuses.

In an embodiment, a pre-charge stage is included in a duration when the load voltage is outputted, in which the value of output current is limited to avoid an inrush current causing damages to the hard disk drive connector during the initial output stage of the load voltage, Therefore, resister-capacitor (RC) circuits used for pre-charging can be omitted, thereby achieving the effect of saving of circuit areas. In general, the inrush current is limited to be lower than the aforementioned predetermined current value, thereby preventing the switching unit from being immediately turned off when the load voltage is outputted.

In an alternative embodiment, the expander detects a feedback signal from the hard disk drive connector to monitor the hard disk drive connector if the power source of the hard disk drive is suspected of being damaged, the expander will send the enabling signal again at this moment to output the load voltage to the hard disk drive connector again, thereby confirming whether the power source is damaged. As described above, the expander can independently send twenty-four enabling signals and detect the voltage level changes of the twenty-four enabling signals. In practice, the function of detecting voltage level changes can be implemented by disposing logic circuits and filter circuits in the expander.

In sum, the present disclosure can monitor a load current of a hard disk drive connector through the aforementioned embodiments so as to reduce possible damages to systems through an active protection method that a load voltage is turned off immediately when an over-current phenomenon occurs, and the processes of turning on the output of the load voltage are retried after the load voltage is turned off for a certain period of time and the causes of the over-current are removed.

Even though the present disclosure is disclosed as above, the disclosure is not used to limit the present disclosure. It will be apparent to those skilled in the art that various modifications and variations can be made to the present disclosure without departing from the spirit or scope of the invention; thus, it is intended that the range protected by the present disclosure should refer to the scope of the following claims.

What is claimed is:

1. A server with a power source protection system, the server comprising:
a power-controlling device, comprising:
an input unit configured to receive an input voltage;
an output unit configured to output a load voltage;
a switching unit coupled between the input unit and the output unit; and
a processor coupled to the switching unit and configured to monitor a load current and control the switching unit to turn on or off an output of the load voltage; and
a hard disk drive connector coupled to the output unit and configured to receive the load voltage;
wherein when the load current exceeds a predetermined current value, the processor turns off the switching unit for a cut-off period; and after the cut-off period, the processor retries to turn on the switching unit to output the load voltage.

2. The server of claim 1, further comprising:
an expander configured to send an enabling signal to the processor to turn on the switching unit to output the load voltage.

3. The server of claim 2, wherein the expander stops sending the enabling signal before detecting that the hard disk drive connector is electrically connected to the output unit.

4. The server of claim 3, further comprising:
a light indicator configured to show a power source status of the hard disk drive connector, wherein a pre-charge stage is included in a duration when the output unit outputs the load voltage.

5. The server of claim 2, wherein when the expander detects that a power source of the hard disk drive connector fails, the expander sends the enabling signal to the processor again to turn on the switching unit and then to output the load voltage.

6. A power source protection method, comprising:
receiving an input voltage;
outputting a load voltage when a switching unit is turned on;
receiving the load voltage by a hard disk drive connector;
monitoring a load current, and controlling the switching unit to turn on or off an output of the load voltage;
turning off the switching unit for a cut-off period when the load current exceeds a predetermined current value; and
retrying to turn on the switching unit to output the load voltage after the cut-off period.

7. The power source protection method of claim 6, further comprising:
receiving an enabling signal sent by an expander to turn on the switching unit and then to output the load voltage.

8. The power source protection method of claim 7, further comprising:
stopping sending the enabling signal before the expander detects that the hard disk drive connector is electrically connected to the output unit.

9. The power source protection method of claim 8, further comprising:
showing a power source status of the hard disk drive connector by a light indicator, a pre-charge stage is included in a duration when the load voltage is outputted.

10. The power source protection method of claim 7, wherein,
when the expander detects that a power source of the hard disk drive connector fails, the expander sends the enabling signal to the processor again to turn on the switching unit and then to output the load voltage.
